(19) United States
(12) Patent Application Publication
(10) Pub. No.: US 2006/0237961 A1
(43) Pub. Date: Oct. 26, 2006

(54) Scrapbook and photo album covers

(76) Inventor: Sandra H. Partain, Bossier City, LA (US)

Correspondence Address: John M. Harrison, 2139 E. Bert Kouns, Shreveport, LA, 71105, US

(21) Appl. No.: 11/329,564

(22) Filed: Jan. 12, 2006

Related U.S. Application Data
(60) Provisional application No. 60/674,098, filed on Apr. 25, 2005.

(51) Int. Cl. B42D 1/08

(52) U.S. Cl. 281/22

(57) ABSTRACT

Scrapbook and photo album covers which enhance the aesthetic appearance of scrapbooks or photo albums are disclosed. The scrapbook and photo album covers include a pair of cover panels for attachment to the respective covers of the scrapbook or photo album. An attachment mechanism is provided on each of the cover panels for attaching the cover panels to the respective covers of the book. At least one ribbon connects the cover panels to each other and enhances the aesthetic appearance of the scrapbooks or photo albums.

### CROSS-REFERENCE TO RELATED APPLICATIONS

This application claims the benefit of and incorporates by reference prior filed copending U.S. Provisional Application Ser. No. 60/674,098, Filed Apr. 25, 2005.

### FIELD OF THE INVENTION

This invention relates to scrapbooks and photo albums. More particularly, this invention relates to scrapbook and photo album covers of various design and appearance for enhancing the appearance or aesthetic appeal of scrapbooks and photo albums.

### BACKGROUND OF THE INVENTION

Scrapbooks are commonly used to contain various memorabilia such as newspaper clippings, invitations, pictures and the like as keepsakes. A scrapbook typically includes front and back cardboard covers and a spine to which multiple paper pages are attached. The memorabilia are glued, pasted, taped or otherwise attached to the pages of the scrapbook. A photo album is typically a ringed binder having front and rear covers and a spine to which multiple page-fastening rings are attached. Multiple plastic pages, each having multiple picture-receiving pockets, are provided with ring openings which receive the rings to mount the pages on the rings. Pictures which are inserted and retained in the pockets can be viewed through the transparent plastic of the pages.

It is desirable for scrapbooks and photo albums to have ornate covers which add to the aesthetic appeal of the scrapbooks or photo albums. Therefore, the present invention provides various covers which can be easily applied to the covers of scrapbooks, photo albums, diaries or other books to enhance the aesthetic appeal of the covers.

### SUMMARY OF THE INVENTION

This invention is generally directed to scrapbook and photo album covers which have various designs and can be easily attached to the covers of conventional scrapbooks, photo albums or other books to enhance their aesthetic appeal. In the various embodiments, the scrapbook and photo album covers typically include a pair of cover panels for attachment to the respective covers of the scrapbook or photo album. An attachment mechanism is provided on each of the cover panels for attaching the cover panels to the respective covers of the book. At least one ribbon connects the cover panels to each other and enhances the aesthetic appearance of the scrapbooks or photo albums.

### BRIEF DESCRIPTION OF THE DRAWINGS

The invention will now be described, by way of example, with reference to the accompanying drawings, in which:

FIG. 1 is a perspective view of a first embodiment of the scrapbook and photo album covers of this invention;

FIG. 2 is an exploded, perspective view of the scrapbook and photo album covers shown in FIG. 1, more particularly illustrating typical attachment of the scrapbook and photo album covers to a scrapbook or photo album (in phantom);

FIG. 3 is a perspective view of a second embodiment of the scrapbook and photo album covers, illustrating a multi-ribbon technique for fastening the cover panels to each other, with an upper pair of ribbon strands shown in an untied configuration;

FIG. 4 is a perspective view of a third embodiment of the scrapbook and photo album covers, with an upper pair of ribbon strands shown in an untied configuration;

FIG. 5 is a perspective view of a fourth embodiment of the scrapbook and photo album covers;

FIG. 6 is a perspective view of a fifth embodiment of the scrapbook and photo album covers;

FIG. 7 is a perspective view of a sixth embodiment of the scrapbook and photo album covers, with an upper pair of ribbon strands shown in an untied configuration;

FIG. 8 is a perspective view of a seventh, alternative embodiment to the scrapbook and photo album covers illustrated in FIG. 7; and

FIG. 9 is a perspective view of an eighth embodiment of the scrapbook and photo album covers of this invention, illustrating a crisscrossing ribbon configuration for fastening the cover panels to each other.

### DETAILED DESCRIPTION OF THE INVENTION

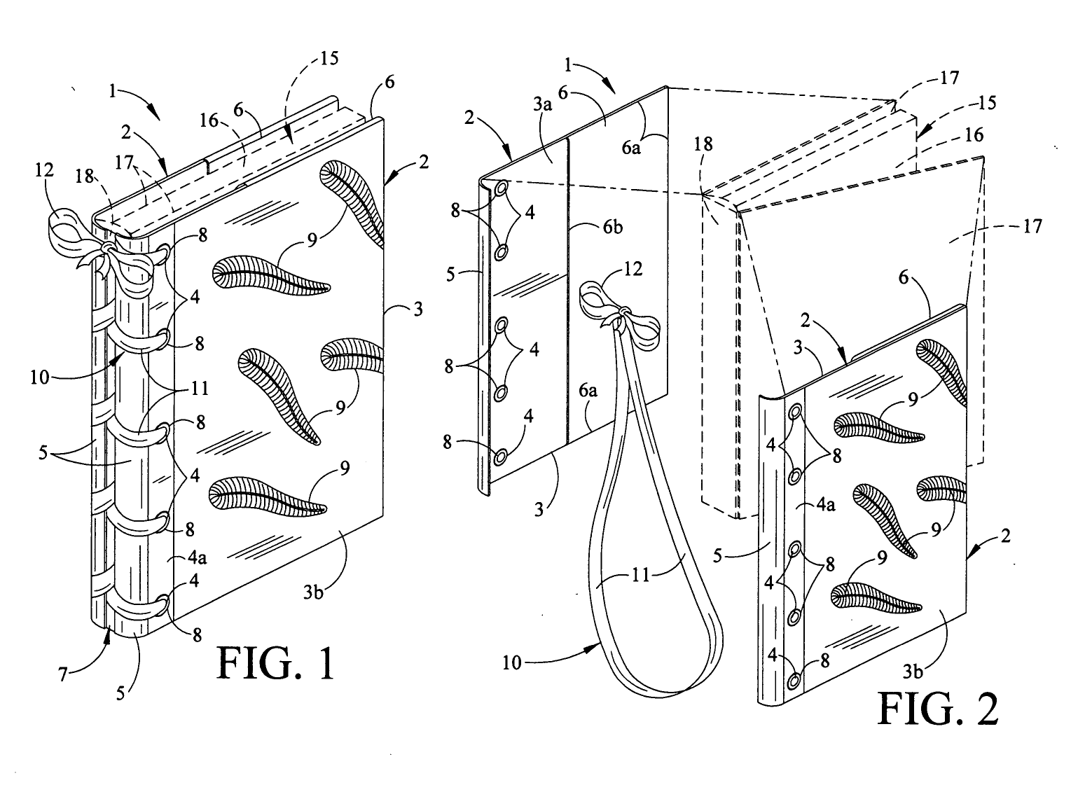

Referring initially to FIGS. 1 and 2 of the drawings, a first illustrative embodiment of the scrapbook and photo album covers, hereinafter covers, of this invention is generally indicated by reference numeral 1. The cover 1 is designed to be removably attached to a scrapbook or photo album 15 (illustrated in phantom) typically having multiple pages 16 and front and rear book covers 17 which are attached to a spine 18. The scrapbook or photo album 15 may be any type of conventional scrapbook or photo album known by those skilled in the art, or alternatively may be a diary, recipe book or any other book which a user desires to decorate using the cover 1. The cover 1 includes a pair of cover panels 2 which may be cotton or any other suitable fabric material. The cover panels 2 may be generally rectangular in shape, as shown, or may be any desired shape which generally corresponds to the shape of the front and rear book covers 17 of the scrapbook or photo album 15.

As illustrated in FIG. 2, each cover panel 2 typically includes a main portion 3 having an inner surface 3a and an outer surface 3b. A decorative pattern 9 having a selected design may be stitched, colored or otherwise provided on the outer surface 3b of the main portion 3 of each cover panel 2. An attachment pocket 6 is typically provided on the inner surface 3a of the main portion 3 of each cover panel 2 to facilitate typically removable attachment of the cover panels 2 to the respective front and rear book covers 17 of the scrapbook or photo album 15, as will be hereinafter described. As illustrated in FIG. 2, each attachment pocket 6 typically includes upper, front and lower attachment edges 6a which are sewn or otherwise attached to the main portion 3 of the cover panel 2 and an inside open edge 6b which remains unattached to the cover panel 2. A panel edge portion 5, spaced-apart from the attachment pocket 6, extends from the main portion 3 and forms the rear edge of each cover panel 2. An elongated attachment strip 4a is provided on the outer surface 3b of each cover panel 2, typically adjacent to the panel edge portion 5, and extends between the upper and lower edges of the main portion 3. Multiple ribbon openings 4, each of which may be reinforced by a reinforcing ring 8, extend through the attachment strip 4a and the main portion 3 of each cover panel 2.

The cover 1 is attached to the scrapbook or photo album 15 typically in the following manner. First, as illustrated in FIG. 2, the front and rear book covers 17 of the scrapbook or photo album 15 are partially opened and inserted in the attachment pockets 6 of the respective cover panels 2. Accordingly, as illustrated in FIG. 1, a panel gap 7 is typically formed between the adjacent panel edge portions 5 of the respective cover panels 2. A ribbon 10, having a continuous, elongated ribbon strand 11, is then progressively threaded through the ribbon openings 4 of the respective cover panels 2 and extended through the panel gap 7 typically in an alternating and cross-crossing fashion, as illustrated in FIG. 1, beginning at the lowermost pair of ribbon openings 4 and proceeding to the higher ribbon openings 4 in the respective cover panels 2. The extending ends of the ribbon strand 11 are finally extended through the uppermost pair of ribbon openings 4 and then tied together to form a bow 12. Therefore, the fastened ribbon 10, in conjunction with the attachment pockets 6, is effective to secure the cover panels 2 on the scrapbook or photo album 15 as well as enhance the aesthetic appearance of the scrapbook or photo album 15. The decorative pattern 9 of selected design on the exterior surface 3b of each cover panel 2 further enhances the aesthetic appearance of the scrapbook or photo album 15. It will be appreciated by those skilled in the art that the cover panels 2 of the cover 1 can be removed from the scrapbook or photo album 15 for washing purposes, for example, and replaced on the scrapbook or photo album 15, as desired, by untying the bow 12; unthreading the ribbon strand 11 from the ribbon openings 4 in the respective cover panels 2; and removing the book covers 17 of the scrapbook or photo album 15 from the attachment pockets 6 of the respective cover panels 2, respectively.

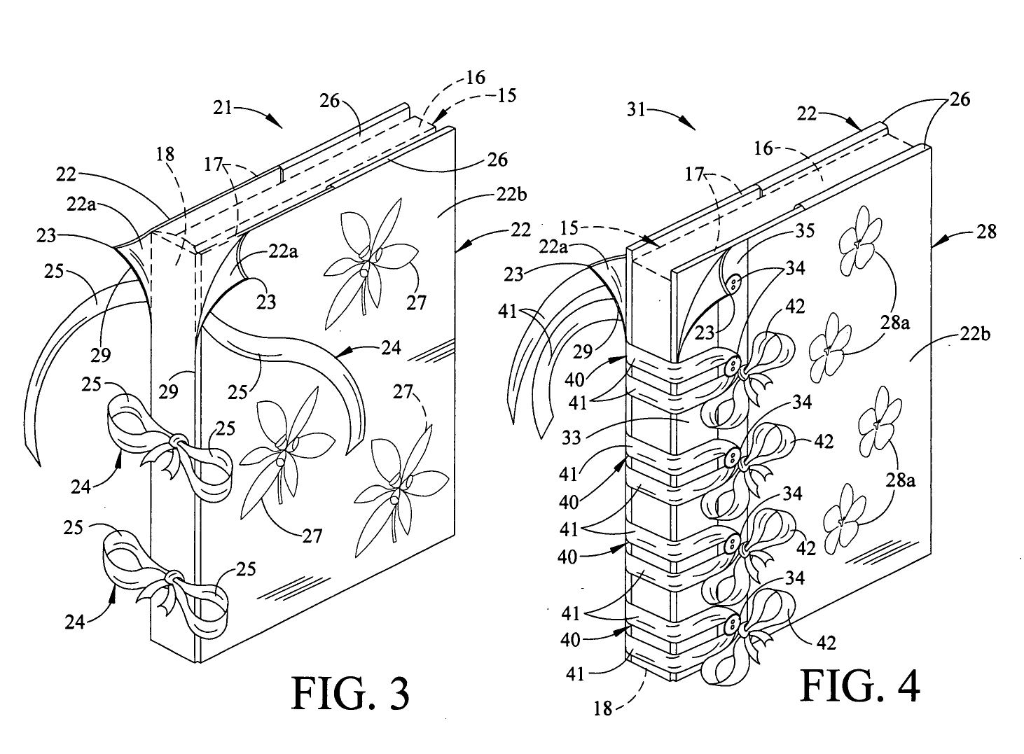

Referring next to FIG. 3 of the drawings, a second illustrative embodiment of the covers of this invention is generally indicated by reference numeral 21. The cover 2i includes a pair of cover panels 22 of selected fabric and having a selected shape. Each cover panel 22 has an inner surface 22a, to which is attached an attachment pocket 26, and an outer surface 22b on which a decorative pattern 27 of selected design is sewn, colored or otherwise provided, as illustrated in phantom. Multiple pairs of companion ribbon strands 25 are sewn, glued or otherwise attached to the rear edges 29 of the respective cover panels 22. Accordingly, the cover 21 is attached to the scrapbook or photo album 15 by initially inserting the book covers 17 of the scrapbook or photo album 15 into the attachment pockets 26 of the respective cover panels 22, with the inner surface 22a of each cover panel 22 facing the exterior surface of the corresponding book cover 17. The ribbon strands 25 of each ribbon strand 25 pair are then tied to each other to form a bow 24 which additionally secures the cover panels 22 on the respective book covers 17 and enhances the aesthetic appearance of the scrapbook or photo album 15. In FIG. 3, the upper pair of ribbon strands 25 is untied such that a corner 23 of the panel 22 is folded away from the book cover 17, whereas the middle and bottom pairs of ribbon strands 25 are tied together to form bows 24 and secure the corresponding portions of the cover panels 22 against the book covers 17.

Referring next to FIG. 4 of the drawings, a third illustrative embodiment of the covers of this invention is generally indicated by reference numeral 31. The cover 31 is similar in design to the cover 21 which was heretofore described with respect to FIG. 3, except multiple binder ribbons 40 are sewn, glued or otherwise attached to a first cover panel 22, having an inner surface 22a and are tied around respective ribbon attachment buttons 34, typically sewn on a second cover panel 28, having a selected decorative pattern 28a. Each binder ribbon 40 includes a pair of adjacent, spaced-apart ribbon strands 41 which extend from the rear edge 29 of the first cover panel 22. A button attachment strip 35 is provided on the outer surface 22b of the second cover panel 28 and extends between the upper and lower edges of the cover panel 28. The ribbon attachment buttons 34 are typically sewn to the button attachment strip 35, in spaced-apart relationship to each other. Accordingly, the cover 31 is attached to the scrap book or photo album 15 by initially inserting the book covers 17 into the respective attachment pockets 26 and then looping the pair of ribbon strands 41 of each binder ribbon 40 around each corresponding ribbon attachment button 34 and tying the ribbon strands 41 into a bow 42.

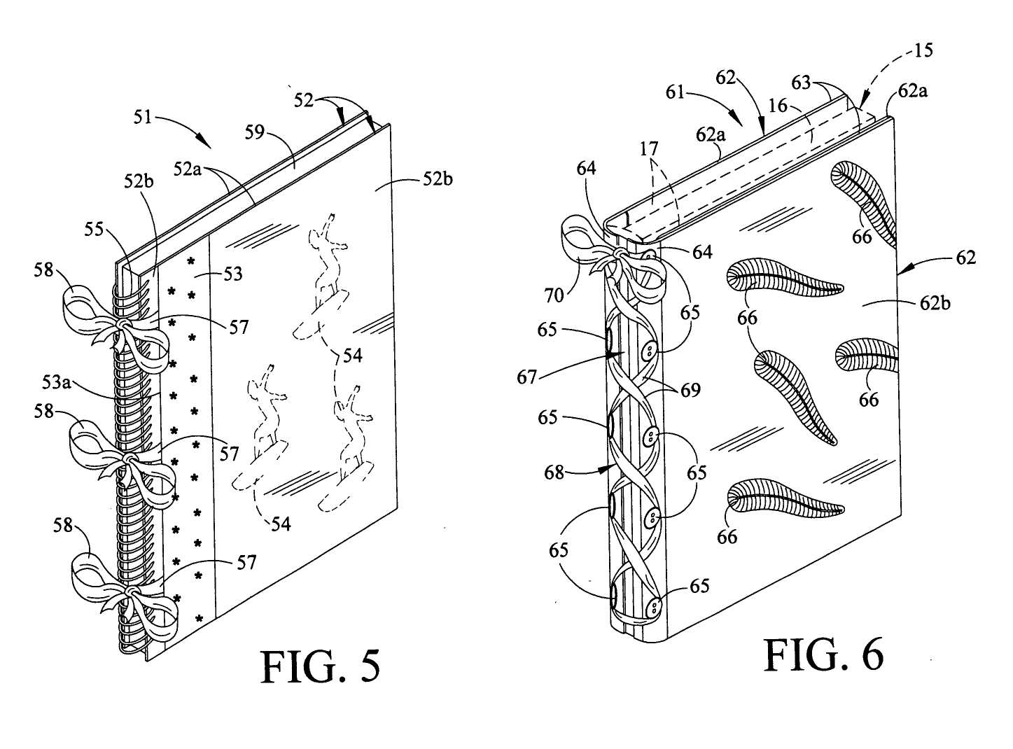

Referring next to FIG. 5 of the drawings, a fourth illustrative embodiment of the covers of this invention is generally indicated by reference numeral 51. The cover 51 generally has a spiral notebook construction and includes a pair of cover panels 52 and multiple pages 59 which are attached to a spiral wire 55. Each cover panel 52 has an inner surface 52a which faces the pages 59 and an outer surface 52b on which may be provided a decorative pattern 54 having a selected design, as illustrated in phantom. An elongated decorative strip 53 may be glued or otherwise provided on the outer surface 52b of each cover panel 52, typically adjacent to the spiral wire 55. Multiple pairs of companion ribbon strands 57 extend from attachment to the rear edges 53a of the decorative strips 53 on the respective cover panels 52. Each pair of companion ribbon strands 57 is tied together to form each of multiple bows 58 that enhance the aesthetic appearance of the cover 51.

Referring next to FIG. 6 of the drawings, a fifth illustrative embodiment of the covers of this invention is generally indicated by reference numeral 61. The cover 61 includes a pair of cover panels 62 of selected material and shape and each having an inner surface 62a fitted with an attachment pocket 63 and an outer surface 62b, on which is provided a decorative pattern 66 of selected design. A button attachment strip 64 is provided on the outer surface 62b of each cover panel 62, typically adjacent to the rear edge of the cover panel 62. Multiple, spaced-apart buttons 65 are typically sewn on the button attachment strip 64. When the cover panels 62 of the cover 61 are attached to the scrapbook or photo album 15, as illustrated, a panel gap 67 may be formed between the adjacent rear edges of the respective cover panels 62. Alternatively, the adjacent rear edges of the cover panels 62 may abut or overlap each other. A ribbon 68 has a continuous ribbon strand 69 which is looped around the buttons 65 of the respective cover panels 62 in an alternating fashion to form a crisscross pattern, as shown. The free ends of the ribbon strand 69 are tied to each other at the top of the cover 61 to form a bow 70. Thus, the ribbon 68 both attaches the cover panels 62 to each other, and to the scrapbook or photo album 15 in conjunction with the attachment pockets 63, and enhances the aesthetic appearance of the scrapbook or photo album 15.

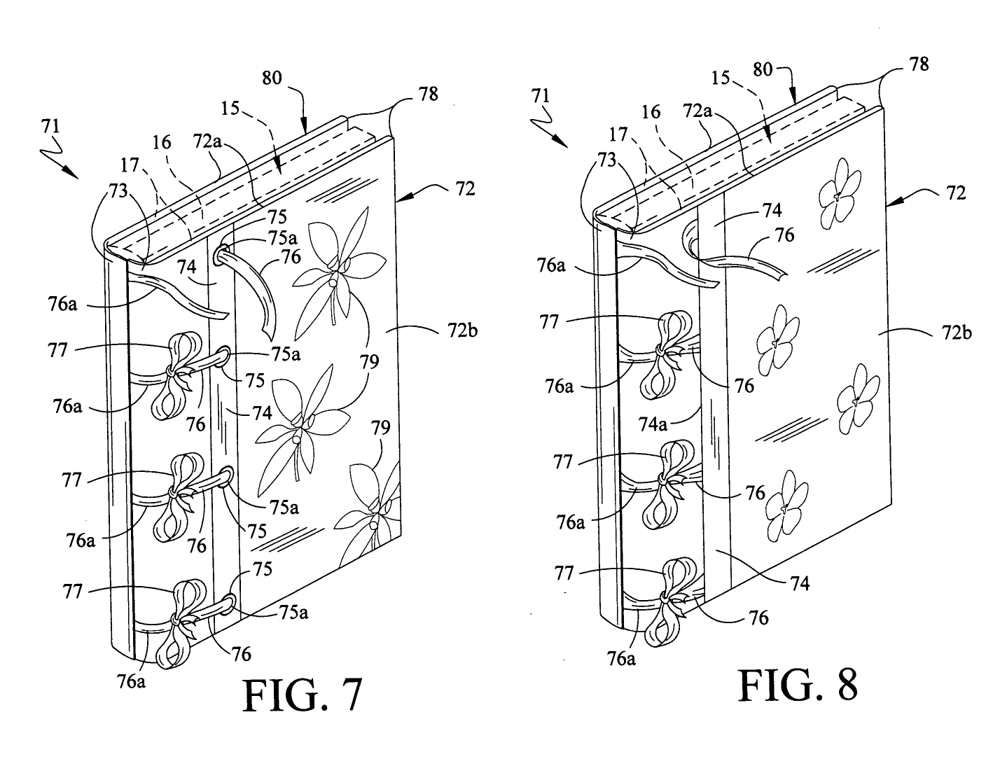

Referring next to FIG. 7 of the drawings, a sixth illustrative embodiment of the covers of this invention is generally indicated by reference numeral 71. The cover 71 includes a first cover panel 72 and a second cover panel 80, each having an attachment pocket 78 on the inner surface 72a and a decorative pattern 79 illustrated in phantom on the outer surface 72b thereof. The rear edges of the respective cover panels 72 and 80 are characterized by panel edge portions 73 which abut against each other, as illustrated, or may overlap. An attachment strip 74 is typically provided on the outer surface 72b of the first cover panel 72. Multiple, spaced-apart ribbon openings 75, each of which may be reinforced by a reinforcing ring 75a, extend through the attachment strip 74 and the cover panel 72. Ribbon strips 76 extend through the respective ribbon openings 75 of the first cover panel 72. Ribbon strips 76a also extend from attachment by sewing, gluing or the like, the panel edge portion 73 of the second cover panel 80 and are paired with the respective ribbon strips 76 that extend through the ribbon openings 75 of the first cover panel 72. Accordingly, the paired ribbon strips 76 and 76a are tied to each other to form bows 77 which secure the first cover panel 72 and the second cover panel 80 to each other and enhance the aesthetic appearance of the scrapbook or photo album 15.

Referring next to FIG. 8 of the drawings, a seventh illustrative embodiment of the covers of this invention is generally indicated by reference numeral 71a The cover 71a is similar in design to the cover 71 which was heretofore described with respect to FIG. 7, except the attachment strip 74 lacks the ribbon openings 75. Multiple ribbon strips 76 are attached, typically by sewing or gluing, to the rear edge 74a of the attachment strip 74, and multiple ribbon strips 76a extend from like attachment to the second cover panel 80 and are paired with the respective ribbon strips 76. As is the case with regard to the cover 71, the pairs of ribbon strips 76 and 76a are tied together to form respective bows 77 which secure the first cover panel 72 and second cover panel 80 to each other and enhance the aesthetic appearance of the cover 71a. A decorative pattern 56 is typically provided on the inner surface 72a of the front cover panel 72.

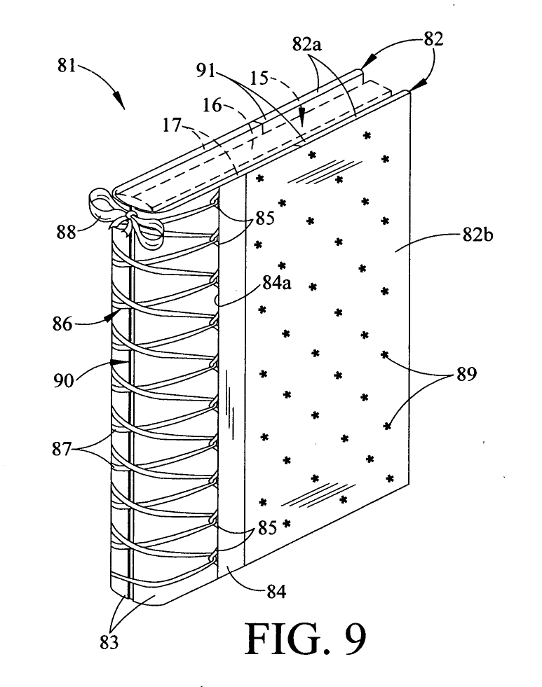

Referring next to FIG. 9 of the drawings, an eighth illustrative embodiment of the covers of this invention is generally indicated by reference numeral 81. The cover 81 includes a pair of cover panels 82, each of which is constructed of a material such as a suitable fabric and has an inner surface 82a and an outer surface 82b. A decorative pattern 89 of selected design is typically provided on the outer surface 82b of each cover panel 82, and attachment pockets 91 are provided on the inner surfaces 82a of the respective cover panels 82. The rear edge of each cover panel 82 is characterized by a panel edge portion 83. An elongated attachment strip 84 is provided on the outer surface 82b of each cover panel 82, typically between the decorative pattern 89 and the panel edge portion 83. Multiple attachment loops 85 are attached to the rear edge 84a of each attachment strip 84 in spaced-apart relationship to each other. When the cover panels 82 are attached to the respective book covers 17 of the scrapbook or photo album 15, a panel gap 90 may be formed between the panel edge portions 83, or the panel edge portions 83 may abut or overlap each other. Beginning at the bottom of the cover 81, the ribbon strands 87 of a binder ribbon 86 are threaded successively through the attachment loops 85 of the respective cover panels 82 typically in a crisscrossing fashion and tied together at a bow 88, typically at the upper end of the panel edge portions 83.

While the preferred embodiments of the invention have been described above, it will be recognized and understood that various modifications can be made in the invention and the appended claims are intended to cover all such modifications which may fall within the spirit and scope of the invention.

Having described my invention with the particularity set forth above,

I claim:

1. A scrapbook and photo album cover for a book having book covers, comprising:
a pair of cover panels;
an attachment mechanism carried by each of said pair of cover panels for attaching said pair of cover panels to the book covers of the book, respectively; and
at least one ribbon connecting said pair of cover panels to each other.

2. The scrapbook and photo album cover of claim 1 wherein said at least one ribbon comprises a plurality of ribbons.

3. The scrapbook and photo album cover of claim 2 wherein said plurality of ribbons comprises a first set of ribbon strands carried by a first one of said pair of cover panels and a second set of ribbon strands carried by a second one of said pair of cover panels for attachment to said first set of ribbon strands, respectively.

4. The scrapbook and photo album cover of claim 3 further comprising an attachment strip provided on said first one of said pair of cover panels and wherein said first set of ribbon strands is carried by said attachment strip.

5. The scrapbook and photo album cover of claim 4 further comprising a plurality of ribbon openings provided in said attachment strip and wherein said first set of ribbon strands extends through said plurality of ribbon openings, respectively.

6. The scrapbook and photo album cover of claim 1 further comprising a plurality of ribbon openings provided in each of said pair of cover panels and wherein said at least one ribbon extends through said plurality of ribbon openings.

7. The scrapbook and photo album cover of claim 6 further comprising a panel gap between said pair of cover panels and wherein said at least one ribbon extends through said plurality of ribbon openings and said panel gap in a crisscrossing pattern.

8. The scrapbook and photo album cover of claim 6 further comprising an attachment strip provided on each of said pair of cover panels and wherein said plurality of ribbon openings extends through said attachment strip.

9. The scrapbook and photo album cover of claim 1 wherein said attachment mechanism comprises an attachment pocket.

10. The scrapbook and photo album cover of claim 1 further comprising a decorative pattern at least one of said pair of cover panels.

11. The scrapbook and photo album cover of claim 1 further comprising a button attachment strip provided on a first one of said pair of cover panels and a plurality of buttons provided on said button attachment strip, and wherein said at least one ribbon comprises a plurality of binder ribbons carried by a second one of said pair of cover panels for attachment to said plurality of buttons, respectively.

12. The scrapbook and photo album cover of claim 1 further comprising a button attachment strip provided on each of said pair of cover panels and a plurality of buttons provided on said button attachment strip, and wherein said at least one ribbon engages said plurality of buttons in a crisscrossing pattern.

13. A scrapbook and photo album cover for a book having book covers, comprising:
a pair of cover panels;
an attachment mechanism carried by each of said pair of cover panels for attaching said pair of cover panels to the book covers of the book, respectively;
a plurality of attachment loops carried by each of said pair of cover panels; and
at least one ribbon extending through said plurality of attachment loops and connecting said pair of cover panels to each other.

14. The scrapbook and photo album cover of claim 13 further comprising an attachment strip provided on each of said pair of cover panels and wherein said plurality of attachment loops is carried by said attachment strip.

15. The scrapbook and photo album cover of claim 13 further comprising a decorative pattern provided on at least one of said pair of cover panels.

16. The scrapbook and photo album cover of claim 13 wherein said attachment mechanism comprises an attachment pocket.

17. A scrapbook and photo album cover comprising:
a pair of cover panels;
a spiral wire connecting said pair of cover panels;
a plurality of pages carried by said spiral wire between said pair of cover panels; and
at least one ribbon connecting said pair of cover panels to each other.

18. The scrapbook and photo album cover of claim 17 wherein said at least one ribbon comprises a plurality of ribbons.

19. The scrapbook and photo album cover of claim 18 further comprising a decorative pattern provided on each of said pair of cover panels.

20. The scrapbook and photo album cover of claim 19 further comprising a decorative strip provided on each of said pair of cover panels adjacent to said spiral wire.
